(19) United States
(12) Patent Application Publication
(10) Pub. No.: US 2020/0032083 A1
(43) Pub. Date: Jan. 30, 2020

(54) SURFACE COVERING WITH WEAR LAYER HAVING DISPERSED THEREIN WEAR-RESISTANT ADDITIVES AND METHOD OF MAKING THE SAME

(71) Applicant: AFI Licensing LLC, Lancaster, PA (US)

(72) Inventors: Daniel P BAKER, Downingtown, PA (US); Gary A. SIGEL, Columbia, PA (US); Dong TIAN, Lancaster, PA (US); Kristy L. GETHING, York, PA (US); Mark J. BOLDIZAR, Lancaster, PA (US)

(21) Appl. No.: 16/340,010

(22) PCT Filed: Oct. 4, 2017
(86) PCT No.: PCT/US2017/055047

§ 371 Date: Apr. 5, 2019

Related U.S. Application Data
(60) Provisional application No. 62/404,534, filed on Oct. 5, 2016.

(51) Int. Cl. C09D 7/61; B32B 27/40; B32B 27/22; B32B 7/04; C09D 175/04; E04F 15/10; C09D 7/40; B32B 27/20

(52) U.S. Cl. CPC C09D 7/61; B32B 2307/554; B32B 27/22; B32B 7/04; C09D 175/04; E04F 15/105; E04F 15/107; C09D 7/69; B32B 27/20; B32B 2250/03; B32B 2255/26; B32B 2255/10; B32B 2255/24; B32B 2264/102; B32B 2264/108; B32B 2264/12; B32B 2471/00; B32B 27/40

(57) ABSTRACT

A wear-resistant composition which includes a polymeric hot-melt binder system which includes at least one wear-resistant additive which includes diamond particles dispersed therein. A surface covering includes a base layer, a wear-resistant layer, and optionally a topcoat layer. The wear-resistant layer is laminated to the base layer. The wear-resistant layer may be formed by dispersing a plurality of wear-resistant additive particles, which include diamonds, into a liquid to form a stable liquid dispersion, blending the stable liquid dispersion into a polymeric resin to form a mixture, and extruding the mixture to form the wear layer.

### CROSS-REFERENCE TO RELATED APPLICATIONS

This application claims the benefit of U.S. Provisional Patent Application No. 62/404,534, filed Oct. 5, 2016, the entire contents of which are incorporated by reference herein.

### FIELD OF THE INVENTION

The present invention relates to a surface covering with a wear layer containing wear-resistant diamond particles, methods of making wear layers and surface coverings as well as products made therefrom.

### BACKGROUND OF THE INVENTION

In order to improve wear, surface coverings are often provided with a topcoat on an outermost surface thereof. Conventional topcoats typically consist of radiation curable coatings, such as ultraviolet curable coatings. The radiation curable coatings are typically resin based mixtures of oligomers or monomers that are cured or cross-linked after being applied to the surface covering by radiation curing. The radiation curing polymerizes the resins to produce a high or low gloss coating having superior abrasion and chemical resistance properties. In order to further enhance the properties of the topcoat, the topcoat may also be provided with wear-resistant particles, such as aluminum oxide, which are dispersed throughout the coating.

Because the above-described topcoat is typically applied and cured after the surface covering has been fully constructed, the application and curing of the topcoat requires additional processing steps after the surface covering has been constructed. Additionally, curing the topcoat with UV lamps incurs extra cost. Further, the uniqueness of the chemistry of the topcoat, particularly when dispersed with the wear resistance particles, requires extra blending and curing steps. These additional steps can result in increased costs as well as increases in material loss due to extra handling of the surface covering. It therefore desirable to develop a surface covering having an outermost surface with added abrasion and chemical resistance properties that can be easily constructed so that unnecessary processing steps can be eliminated and costs can be reduced.

### BRIEF SUMMARY OF THE INVENTION

In one aspect of the invention there is provided a wear-resistant hot-melt coating composition which includes binder composition including a hot-melt polymer and a wear-resistant additive which includes diamond particles.

In another aspect of the invention there is provided a floor covering having enhanced wear-resistance which includes:
a substrate; and
a coating layer including a hot-melt polymer binder composition and a wear-resistant additive which includes diamond particles dispersed therein, wherein the diamond particles are present in amounts of about 1% to about 50% by total weight of the binder composition.

In yet another aspect of the invention, there is provided a surface covering including a laminate structure which includes:
a base layer; and
a wear layer atop the base layer, the wear layer including a polymeric hot-melt binder and wear resistance particles dispersed in the polymer binder; said wear-resistant particles including diamonds.

In another aspect of the invention there is provided, a process for forming a surface covering which includes:
mixing together polymeric binder and wear-resistant particles including diamonds to form a wear-resistant composition;
forming a coating composition from the wear-resistant composition; and
applying the film to a base layer;
wherein the film is formed by at least one of extruding or calendaring the wear-resistant composition into the film.

In another aspect of the invention there is provided a surface covering which includes a first surface opposite a second surface, the surface covering further comprising a laminate structure including: a base layer; a wear layer atop the base layer, the wear layer having a first thickness as measured from an upper surface to a lower surface of the wear layer, the wear layer comprising a polymeric hot-melt binder and at least one wear resistance additive which includes diamond particles dispersed in the polymer binder; and optionally a topcoat layer atop the wear layer, the topcoat layer having a second thickness as measured from an upper surface to a lower surface of the topcoat layer. The surface covering is particularly useful as floor coverings, including tiles, sheets and laminates.

In another aspect of the invention there is provided a process for forming a surface covering which includes: mixing together polymeric hot-melt binder and at least one wear-resistant additive which includes diamond particles to form a wear-resistant composition; forming a film from the wear-resistant composition; and applying the film to a base layer; wherein the film is formed by at least one of extruding or calendering the wear-resistant composition into the film.

In another aspect of the invention there is provided a surface covering which includes a laminate structure which includes: a base layer having an upper surface opposite a lower surface; a wear-resistant layer atop the base layer, the wear-resistant layer including a polymeric hot-melt binder and at least one wear-resistance additive which includes diamond particles; and a topcoat layer atop the wear-resistant layer, the topcoat layer desirably being a continuous layer and desirably being substantially free of the wear-resistant additive particles.

In another aspect of the invention there is provided a surface covering which includes a laminate structure which includes:
a base layer having an upper surface opposite a lower surface;
a wear layer atop the base layer, the wear layer including a polymeric binder
which includes a polyurethane hot-melt resin and a wear-resistance additive including diamond particles; and
optionally a topcoat layer atop the wear layer, the topcoat layer being a continuous layer and being substantially free of the wear-resistant particles.

### BRIEF DESCRIPTION OF THE DRAWINGS

FIG. 1 is a schematic illustration of a surface covering according to an embodiment of the invention;

FIG. 2 is a schematic illustration of an alternate embodiment of the invention showing the surface covering with a topcoat;

FIG. 3 is a schematic illustration of a further alternate embodiment of the invention showing the surface covering with a print layer having an ink pattern on a back surface thereof; and

FIG. 4 is a schematic illustration of a still further alternate embodiment of the invention showing the surface covering with a print layer having an ink pattern on a top surface thereof.

### DETAILED DESCRIPTION OF THE INVENTION

For purposes of the present invention, the following definitions will apply:

“Average diameter” is calculated by measuring the diameter of each piece of a material (e.g., diamond material), and then calculating the average. If the material (e.g., diamond material) has different diameters, e.g., if the material (e.g., diamond material) is not a sphere, then the average diameter is calculated by measuring the longest diameter of each piece of material (e.g., diamond material), and then calculating the average. It should be noted that any calculations involving material (e.g., distance between pieces of a material, distance of some material from a layer's surface, etc.) should use the relevant edge of the material, as opposed to the center of the material.

“Coating” or “coating layer” means a composition that has been applied to a surface, such as a substrate, and then cured. “Coating” may refer to a single coating layer or to the totality of coating layers. Coating layers may be the same as, or different from, each other in terms of composition, average thickness, etc.

“Curing” or “cured” or similar means the process whereby polymeric materials are formed by cross-linking, creating properties such as (but not limited to) increased viscosity and hardness. The curing process may be initiated via several methods, e.g., application of heat and/or radiation such as (but not limited to) light, e.g., visible light or UV light. A “complete cure” or similar means that all polymeric materials have cross-linked. “Substantially complete cure” or similar means that the vast majority of polymeric materials have cross-linked such that it is difficult or impossible to determine if a “complete cure” has taken place. A “partial cure” or “partially complete cure” or similar means that the curing process has been initiated but has not yet reached the point of meeting the definition of a “complete cure” or of a “substantially complete cure”.

“Dispersing agent” is any chemical or compound that acts to distribute, or to assist in distributing, at least the abrasion resistant material throughout a composition prior to curing.

“Floor covering” is any substrate which may be useful in creating a floor surface in building operations. The substrate forming the floor covering may be either coated with at least one coating layer, or it may be uncoated.

“Substrate” is any material upon which one or more coating layers are able to be applied. In some instances, a substrate coated with a coating layer may be considered to form another substrate. For example, a substrate may be, e.g., a vinyl tile. However, a vinyl tile with a coating layer on its surface may also be considered to be a substrate.

Other relevant information and/or definitions may be found in several other applications that were filed concurrently or approximately with the present application, bearing Attorney Reference Nos. 2589-21 P (U.S. Provisional Application Ser. No. 62/404,479, filed Oct. 5, 2016, titled “Floor Coatings Comprising a Resin, a Cure System and Diamond Particles and Methods of Making the Same”), 2589-22 P (U.S. Provisional Application Ser. No. 62/404,389, filed Oct. 5, 2016, titled “Testing of Wear Resistance”), 2589-23 P (U.S. Provisional Application Ser. No. 62/404,445, filed Oct. 5, 2016, titled “Coating Compositions Including Diamond and Either Cationic Curable Resin Systems or Thiol-Ene Curable Systems”), and 2589-24 P (U.S. Provisional Application Ser. No. 62/404,503, filed Oct. 5, 2016, titled “LED Curable Coatings for Flooring Comprising Diamond Particles and Methods of Making the Same”); each of which is incorporated by reference herein in its entirety.

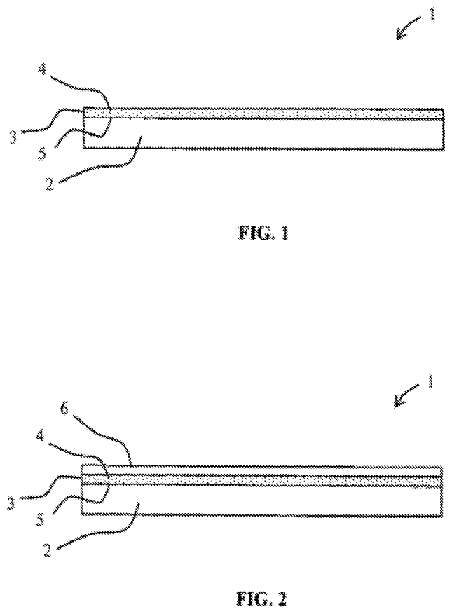

FIG. 1 shows a surface covering 1 according to an embodiment of the invention. The surface covering 1 shown and described herein may be a resilient surface covering, which may be provided, for example, in the form of a tile or a continuous sheet. As shown in FIG. 1, the surface covering 1 comprises a base layer 2 and a wear-resistant layer 3. The wear layer 3 is provided with at least one wear-resistant additive which includes diamond particles dispersed therein 4 and is printed with an ink pattern 5 on a bottom surface thereof. It will be appreciated by those skilled in the art, however, that the surface covering 1 is not limited to the structure shown and described herein. For example, the surface covering 1 may comprise additional base layers, film layers, and/or a topcoat. Further, the thickness of the base layer 2 and the wear-resistant layer 3 may be varied depending on the desired characteristics of the surface covering 1.

### The Base Layer of the Surface Covering

The present invention includes laminate structures which have a base layer and a wear-resistant layer. The base-layer 2 may have a thickness of about 35-170 mils and includes a polymeric resin which serves as a base-layer binder for additional components, such as fillers, plasticizers, stabilizing aids, processing aids and pigments. The base-layer binder may be, for example, a polymeric resin, such as a vinyl resin, mixed with a plasticizer, stabilizer, and processing aids. The polymeric resin may include, for example, a homopolymer, copolymer, terpolymer or combinations thereof. The homopolymer may include, for example, polyvinyl chloride, polyvinyl acetate, polyvinyl propionate, polyvinyl butyrate, polymerized vinylidene chloride, polymerized acrylic acid, polymerized ethyl acrylate, polymerized methyl acrylate, polymerized propyl acrylate, polymerized butyl acrylate, polyethylene, polypropylene, or mixtures thereof. The copolymer may include, for example, polyvinyl chloride/polyvinyl acetate, vinylidene chloride/vinyl chloride, methyl methacrylate/vinyl chloride, methyl acrylate/eth acrylate, ethyl acrylate/butyl acrylate copolymer, ethylene propylene copolymers, ethylene styrene copolymers, or mixtures thereof. The terpolymers may include, for example, polyvinyl chloride/polyvinyl acetate/carbon monoxide, or polyvinyl chloride/polyvinyl; Acetate/acrylic polymer. Alternatively, the base-layer binder may be, for example, a thermoplastic polyester resin including at least one recyclable or renewable component. Additional base-layer binders may include polyethyleneterephthalate (PET), glycolated polyethyleneterephthalate (PETG), polybutylene terephthalate (PBT), polypropylene terephthalate (PPT), or a thermoplastic ionomer resin, such as SURLYN from E. I. du Pont de Nemours and Company. The polymeric resin may also consist, for example, of recycled material, such as recycled polyethyleneterephthalate (PET) or polybutylene terephthalate (PBT) modified by renewable polyesters.

Each of the layers of a laminate structure may include various additives such as plasticizers, stabilizers, catalysts, modifiers, pigments, dyes, tints fillers and the like.

The plasticizer may include, for example, ester type plasticizers, such as orthophthalates, non-orthopthalates, phosphates, benzoates, modified benzoates, tartrates, sebacates, adipates, citrates, hexanoates, soyates, trimellitates, sulfonates, rubbery plasticizers, such as butadiene-styrene copolymer, butadiene-acrylonitrile copolymer, or ethylene vinyl acetate, or other materials which function as plasticizers, such as epoxidized drying oils, aromatic hydrocarbon condensates and, chlorinated paraffins. The amount of plasticizer useful may vary from about 0% to about 20% by weight of the layer in which it is used.

Where certain flexible soft vinyl resins are used, such as polymers containing large proportions of ethyl acrylate, no plasticizer may be needed. The stabilizer may include, for example, a mixed metal stabilizer, such as a calcium-zinc composition. The processing aids may include, for example, hydrocarbon resins, polystyrene resins, impact modifiers, flow modifiers, or fusion promoters, such as acrylic copolymers or polyethylene oxide.

The filler may include, for example, an inorganic or organic material, such as calcium carbonate, magnesium carbonate, silica, diatomaceous earth, dolomite, clay, or mixtures thereof. The filler may be a recyclable or renewable material. The optional pigment may include, for example, titanium dioxide, iron oxides, phthalocyanine blue, phthalocyanine green, azo red, benzidene yellow, carbon black, or mixtures thereof.

The formulation of the base layer 2 may contain, for example, about 5 to about 80% weight of the binder, preferably about 10 to about 60% weight of the binder, and more preferably about 15 to about 35% weight of the binder. Additionally, the base layer 2 contains, for example, about 20 to about 95% weight of the filler, preferably about 40 to about 90% weight of the filler, and more preferably about 65 to about 85% weight of the filler.

### Wear-Resistant Composition And Layer

The wear-resistant layer 3 may be a coating composition comprising a polymer hot-melt binder system having dispersed therein at least one with the wear-resistant additive which includes diamond particles 4. The wear-resistant layer 3 may have a thickness of about 1-40 mils, preferably about 2 mils to about 12 mils, and more preferably about 2 to about 4 mils. The polymer hot-melt binder system may include, for example, a polymeric hot-melt resin mixed with an additive package and a plasticizer. In one particularly useful aspect of the invention the polymeric hot-melt resin may be a resin having a backbone prepared from a polyurethane, polyether, polyester, polyetherester, polyesterether, polyolefin, polycaprolactone, polybutadiene, polycarbonate, polyacetal, polyester amide, styrene-butadiene-styrene (SBS), epoxy, polythioether or combinations thereof. Desirably the hot-melt resin is a reactive hot-melt, meaning that it has reactive groups which serve to polymerize even after the hot-melt is cooled and physically set. For example, the hot-melt may have moisture-curing groups present which may react with ambient moisture to crosslink once the hot-melt has be shaped to the desired form. Such reactive groups present on the hot-melt binder system may be selected from isocyanate groups, alkoxy groups, silanol groups and combinations thereof.

Examples of hot-melts useful in the present invention include, without limitation, those described in U.S. Pat. No. 4,946933; U.S. Pat. No. 5,166,302; U.S. Pat. No. 6,015,865; U.S. Pat. No. 8,163,824; U.S. Pat. No. 9,023946; Publication US20030010442 A1; all of which are incorporated in their entirety by reference herein.

Desirably the hot-melt binder is a polyurethane-containing polymer having reactive isocyanate groups present, which moisture cure.

The hot-melt binder may also be a clear layer that contains the wear-resistant additive and which may be then laminated to the another layer or substrate. A combination of clear and non-clear layers may be useful as well

Wear-resistant additives can be added to the hot-melt binder by mixing the additives into the hot-melt, or the additives may be sprinkled onto the surface of the hot-melt resin and embedded into the hot-melt using heat and pressure, e.g. calendaring or laminating, such as using a flat-bed press.

The diamond additive dispersed in the polymeric hot-melt includes, but is not limited to, diamond particles, diamond dust, diamond shards, diamond fragments and whole diamonds, or combinations of the foregoing. In related aspects the average diameter of the diamond material may be in the nanometer range or in the micrometer range. For example, when in the nanoparticle range, the average diameter may be in ranges of from about 0.1 nm to about 1,000 nm; preferably from about 0.2 nm to about 900 nm; more preferably from about 0.5 nm to about 800 nm; even more preferably from about 1 nm to about 600 nm; yet even more preferably from about 2 nm to about 500 nm; and most preferably from about 10 nm to about 500 nm, from about 20 nm to about 500 nm, from about 25 nm to about 250 nm, from about 35 nm to about 175 nm, from about 50 nm to about 150 nm, from about 75 nm to about 125 nm or from about 20 nm to about 40 nm.

When in the micrometer range, the average diameter of the diamond additive may be in ranges of from about 0.01 μm to about 100 μm; preferably from about 0.1 μm to about 75 μm; more preferably from about 0.5 μm to about 50 μm; even more preferably from about 0.75 μm to about 25 μm; yet even more preferably from about 1 μm to about 10 μm; and most preferably from about 1 μm to about 5 μm, from about 5 μm to about 10 μm, from about 2.5 μm to about 7.5 μm, or from about 6 μm to about 10 μm.

The wear-resistant particle sizes have a narrow distribution which may have a standard deviation of less than 35% of the average particle size. In some aspects of the invention a ratio of the average wear-resistant coating layer thickness to average wear-resistant additive particle size ranges from 0.6:1 to 2:1.

The wear-resistant additive particles which include diamond particles, may be present in an amount ranging from about 1% to about 50% , desirably about 1% to about 20% and even more desirably about 2 wt. % to about 6 wt.% based on the total weight of the wear-resistant coating composition.

In order to determine wt. %, a sample size of a cured coating layer may be tested. The sample may be of any size, e.g., 1 cm², 10 cm², 100 cm², or any other size useful for testing. The thickness of the coating layer sample being tested should, statistically, have the same average thickness as the rest of the coating layer.

Additional wear-resistant additives may also be included, including more than one form or size of diamond additive. The second wear-resistant additive may be any material that has a Mohs hardness value of at least 6 including, but not limited to, aluminum oxide and feldspar, or a combination of both. The average diameter of one of the wear-resistant materials may be in the nanometer range, while the other abrasion resistant material may have an average diameter in the micrometer range. Alternatively, both abrasion resistant materials may have average diameters in the nanometer range, or both abrasion resistant materials may have average diameters in the micrometer range

The hot-melt binder may further include a cure system which includes one or more plasticizers, catalysts, stabilizers, modifiers, processing aids, internal and/or external lubricant packages, ultraviolet absorbers, tints, pigments, other specialty additives, or any combination thereof, such as those described herein with respect to the base-layer.

For a polymer hot-melt binder system comprising a polyurethane resin, the additive package may include, for example, a stabilizer, a modifier, an acrylic processing aid, an internal and external lubricant package, an ultraviolet absorber, tint, other specialty additives, or any combination thereof.

When present, the stabilizer may be incorporated at a level of about 0.7 to about 3 parts per hundred parts by weight of the polymeric hot-melt resin (phr) and [may comprise for example, a thermal stabilizer, such as organo tin, calcium zinc, or other metallic salt.

A hot-melt resin modifier may be present in the film, for example, at a level of about 4 to about 15 parts per hundred parts by weight of the polymeric hot-melt resin (phr) and may include, for example, an impact strength modifier, such as methylmethacrylate butadiene styrene (MBS), acrylonitrile butadiene styrene (ABS), or all-acrylic. An acrylic processing aid may be present in the film, for example, at a level of about 1-3 parts per hundred parts by weight of the polymeric resin (phr). An internal and external lubricant package may be present in the film, for example, at a level of about 0.2 to about 1.5 parts per hundred parts by weight of the polymeric hot-melt resin (phr) and may include, for example, glycerol monooleate, glycerides, or ester wax. The ultraviolet absorber may be present in the film, for example, at a level of about 0.0 to about 0.8 parts per hundred parts by weight of the polymeric hot-melt resin (phr). The tint may include, for example, transparent or filled titanium dioxide opaque color tints or transparent clear tints.

In one aspect of the invention, the film may be a rigid film, and more preferably a rigid vinyl film. A rigid film is generally known in the art as a film that is free of or substantially free of plasticizers, e.g., comprising less than 5 parts of the plasticizer per hundred parts by weight of the polymeric resin (phr). It will be appreciated by those skilled in the art, however, that the film may alternatively be a semi-rigid film or a flexible film. A semi-rigid film is defined herein as a film which includes about 5 to about 10 parts of the plasticizer per hundred parts by weight of the polymeric hot-melt resin (phr). A flexible film is defined herein as a film comprising greater than about 10 parts of the plasticizer per hundred parts by weight of the polymeric hot-melt resin (phr).

The wear-resistant additive particles 4 dispersed in the polymer hot-melt binder system of the film include diamond particles and optionally additional wear-resistant additives such as aluminum oxide (Al₂O₃) particles, crystalline classes of silicon carbide, hard plastics, reinforced polymers, nylon, organics, or any combination thereof.

The wear-resistant layer 3 may be prepared by dispersing the wear-resistant particles 4 in a compatible liquid to form a stable liquid dispersion. The liquid may be, for example, a liquid component of the polymer hot-melt binder system, such as the plasticizer or a liquid component of the additive package. The stable liquid dispersion may then be blended in the polymeric hot-melt resin, as well as any remaining components of the polymer hot-melt binder system, using a high speed mixer to a temperature of about 60-90 degrees Celsius to form a mixture. The mixture containing the polymer hot-melt binder system and the wear-resistant particles 4 is thermally compressed, fused, and compounded and preferably extruded or continuously mixed to a temperature of about 160-200 degrees Celsius. The mixture is then preferably calendared to form the wear layer 3. For the wear layer 3, comprising the vinyl resin, the calendaring temperatures may range, for example, from about 190-225 degrees Celsius. Because the processes of blending, compounding, extruding, and calendaring a mixture to form a film is well known in the art, further description thereof has been omitted.

As shown in FIG. 1, after formation of the wear layer 3, the wear layer 3 is printed with the ink pattern 5. In the embodiment shown and described herein, the wear layer 3 is provided with the ink pattern 5 on a back surface thereof. It will be appreciated by those skilled in the art, however, that the wear layer 3 may alternatively be clear or provided with an ink pattern on a top surface thereof in addition to or as an alternative to providing the ink pattern 5 on the back surface. The wear layer 3 may also optionally be mechanically and/or chemically embossed. The wear layer 3 is then laminated to the base layer 2. The wear layer 3 may be laminated to the base layer 2, for example, using a conventional standard stack press or a conventional rolling nip-type laminator.

In certain aspects of the invention, the invention provides a floor covering which includes a substrate prepared according to any of the above-described methods. The substrate may be, but is not necessarily limited to, tile (e.g., vinyl tile, ceramic tile, porcelain tile and wood tile), linoleum, laminate, engineered wood, wood (e.g., ash, birch, cherry, exotic, hickory, maple, oak, pecan and walnut), cork, stone, bamboo, vinyl sheet, and combinations of any of the foregoing.

In another aspect of the invention, the abrasion resistant material may protrude from the top surface of a coating layer at a distance of from about 1-50% of the average coating thickness. The ratio of the average coating thickness to the average diameter of the abrasion resistant material may sometimes be in the range of from about 0.6:1 to about 2:1. In some instances, the average distance between two pieces of abrasion resistant material is from about 20-75 μm.

FIG. 2 shows an alternate embodiment of the invention. As shown in FIG. 2, the wear layer 3 is provided with a topcoat 6. The topcoat 6 is coated in a liquid or flowable form onto the wear layer 3 at a thickness of about 1 mil and then cured. It is known to cure the topcoat 6 by controlled exposure to radiation, such as ultraviolet or electron beam radiation. The topcoat 6 may be, for example, a radiation curable coating, such as an acrylated urethane or acrylated polyester. Alternatively, the topcoat (not shown) may be a radiation curable biobased coating comprising a biobased component. The biobased component may be, for example, a biobased polyol, acrylated biobased polyol, or biobased resin derived, for example, from renewable and/or biobased materials, such as plant oils, polyester, polyester-ether, vegetable oils, corn, cellulose, starch, sugar, or sugar alcohols. The topcoat 6 provides additional resistance to marking and scuffing to the outermost surface of the surface covering 1.

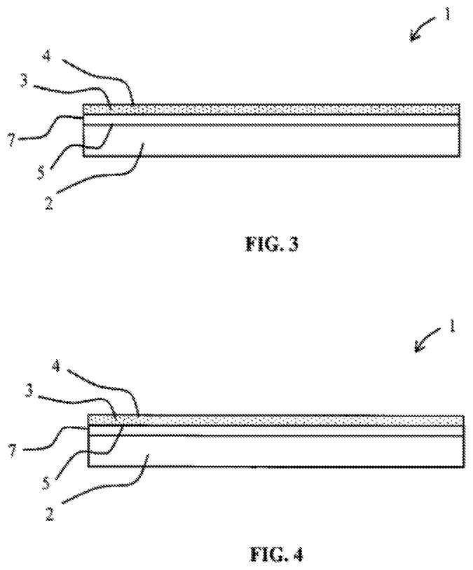

FIGS. 3-4 show a further alternate embodiment of the invention. As shown in FIGS. 3-4, the surface covering Inlay also be provided with a print layer 7. The print layer 7 may be, for example, a rigid film or semi-rigid film comprising, for example, a polymeric resin mixed with an additive package and a plasticizer.

The polymer binder system may comprise, for example, a polymeric resin mixed with an additive package and a plasticizer. The polymeric resin may be, for example, a vinyl resin, such as polyvinyl chloride. Alternatively, the polymeric resin may be, for example, polyethyleneterephthalate (PET), glycolated polyethyleneterephthalate (PETG), polybutylene terephthalate (PBT), polypropylene terephthalate (PPT), or a thermoplastic ionomer resin, such as SURLYN from E. I. du Pont de Nemours and Company. The polymeric resin may also consist, for example, of recycled material, such as recycled polyethyleneterephthalate (PET) or polybutylene terephthalate (PBT) modified by renewable polyesters. The plasticizer may include, for example, unsaturated glycerides or phthalate esters. The additive package may include, for example, a stabilizer, a modifier, an acrylic processing aid, an internal and external lubricant package, an ultraviolet absorber, tint, other specialty additives, or any combination thereof.

In FIGS. 3-4, the print layer 7 is printed with the ink pattern 5 instead of the wear layer 3. In FIG. 3, the print layer 7 is provided with the ink pattern 5 on a back surface thereof. In FIG. 4, the print layer 7 is provided with the ink pattern 5 on a top surface thereof. It will be appreciated by those skilled in the art, however, that the print layer 7 may alternatively be provided on both the back surface and the top surface of the print layer 7. The print layer 7 may also optionally be mechanically and/or chemically embossed. Additionally or alternatively, the wear layer 3 could also be provided with a print layer on a back surface and/or top surface thereof and/or could he mechanically and/or chemically embossed.

The print layer 7 is laminated to the base layer 2 between the base layer 2 and the wear layer 3. The print layer 7 is laminated to the base layer 2 between the base layer 2 and the wear layer 3, for example, using a conventional standard stack press or a conventional rolling nip-type laminator.

In the surface covering 1 according some embodiments of the invention described herein, the wear layer 3, may form the outmost surface of the surface covering 1, and may include dispersed therein the wear-resistant additive 4 comprising diamond particles, which provides the wear layer 3 with added abrasion and chemical resistance properties. The surface covering 1 according to the invention thereby can be easily constructed to have an outermost surface with added abrasion and chemical resistance properties while eliminating unnecessary processing steps and reducing costs.

The foregoing illustrates some of the possibilities for practicing the invention. Many other embodiments are possible within the scope and spirit of the invention. For example, although the wear layer 3, is shown and described herein as being used in conjunction with the surface coverings 1, which are related to flooring surfaces, it will be appreciated by those skilled in the art that the wear layer could be used in conjunction with other types of surface coverings, such as wall paper, countertops, automobile structures, furniture surfaces, protective case surfaces, and the like, and still exhibit the same added abrasion and chemical resistance properties. It is, therefore, intended that the foregoing description be regarded as illustrative rather than limiting, and that the scope of the invention is given by the appended claims together with their full range of equivalents.

1. A wear-resistant hot-melt coating composition comprising:
a binder composition comprising a hot-melt polymer and a wear-resistant additive comprising diamond, particles.

2. The wear-resistant hot-melt coating composition of claims 1, wherein the diamond particles have an average particle size of about 0.1 nm to about 1000 nm.

3. The wear-resistant hot-melt coating composition of claim 1, wherein the diamond particles have an average particle size of about 0.1 μm to about 75 μm.

4. The wear-resistant hot-melt coating composition of claim 1, wherein the diamond particles are present in the amount of about 1% to about 50% 1′/i: to about 50% by weight of the total wear-resistant composition.

5. The wear-resistant hot-melt coating composition of claim 1, wherein the hot-melt polymer is a urethane hot-melt containing moisture curing groups.

6. The wear-resistant hot-melt coating composition of claim 1, wherein the moisture curing groups are isocyanate groups.

7. A floor covering having enhanced wear-resistance comprising:
a substrate; and
a coating layer comprising a hot-melt polymer binder composition and a wear-resistant additive comprising diamond particles dispersed therein, wherein the diamond particles are present in amounts of about 1% to about 50% by total weight of the binder composition.

8. The floor covering composition of claim 7, wherein the diamond particles have an average particle size of about 0.1 nm to about 1000 nm.

9. The floor covering composition of claim 7, wherein the diamond panicles have an average particle size of about 0.1 μm to about 75 μm.

10. A surface covering comprising a laminate structure comprising:
abase layer; and
a wear layer atop the base layer, the wear layer comprising a polymeric hot-melt binder and wear resistance particles dispersed in the polymer binder: said wear-resistant particles comprising diamonds.

11. The surface covering of claim 10, further including a topcoat layer over the wear layer.

12. The surface covering of claim 10, wherein the ratio of the base layer thickness to the wear-layer thickness is from about 1:1 to about 1:40.

13. The surface covering of claim 10, wherein the ratio of the wear-resistant thickness to the topcoat layer is from about 1:1 to about 1:12.

14. The surface covering of claim 10, wherein the laminate structure further comprises a print layer positioned between the base layer and the wear layer.

15. The surface covering of claim 10, wherein the print layer is embossed.

16. The surface covering of claim 10, wherein the wear resistance particles have a size ranging from about 10 nm to about 500 nm.

17. The surface covering of claim 1, wherein the wear resistance particles are present in an amount of about 1% to about 50% by weight of the wear layer.

18. The surface covering of claim 10, wherein the laminate structure has a thickness ranging from about 35 mils to 170 mils.

19. The surface covering of claim 1, wherein the first thickness of the wear layer ranges from about 1 mil to about 40 mils.

20-37. (canceled)
